(19) United States
(12) Patent Application Publication
(10) Pub. No.: US 2012/0176081 A1
(43) Pub. Date: Jul. 12, 2012

(54) ENERGY STORAGE APPARATUS COMPRISING AN ENERGY STORAGE DEVICE

(75) Inventor: Tim Schaefer, Niedersachswerfen (DE)

(73) Assignee: LI-TEC BATTERY GMBH, Kamenz (DE)

(21) Appl. No.: 13/390,704

(22) PCT Filed: Jul. 29, 2010
(86) PCT No.: PCT/EP2010/004650

§ 371 Date: Mar. 28, 2012

(30) Foreign Application Priority Data
Aug. 17, 2009 (DE) 10 2009 037 725.5

(51) Int. Cl. H02J 7/00

(52) U.S. Cl. 320/103

(57) ABSTRACT

An energy storage apparatus including at least first and second energy storage devices to supply, or also consume, an electric current. At least the second energy storage device is an electrochemical energy storage device. A control device controls at least supply of electric current by at least one of the energy storage devices and can also control consumption of electric current by at least one of the energy storage devices. Energy density of the second energy storage device is higher than energy density of the first energy storage device; energy density is defined as the ratio between energy that can be stored in the energy storage device in a charged state and weight of the energy storage device. The control device can trigger the first energy storage device to supply electric current when the electric current exceeds a predetermined threshold value for the current strength.

The present invention relates to an energy storage device and a method for the operation thereof. The invention is described in connection with galvanic cells and the supplying of automotive drives. It is pointed out that the invention can also be used independently of the design of the galvanic cells or independently of the nature of the consumer supplied.

Energy storage devices with galvanic cells for supplying automotive drives in particular are known from the prior art. Common to some designs is the fact that the operation period of the galvanic cells achievable in practical use remains substantially behind the operation period under ideal operating conditions.

The invention is therefore based on the object of increasing the useful operation period of the energy storage device or of the galvanic cells thereof.

This is achieved according to the invention by means of the teaching of the independent claims relating to an energy storage device and a method for the operation thereof. Developments of the invention which are to be preferred are the subject of the subclaims.

The object is achieved with an energy storage device which has one or a plurality of first energy storage apparatuses and one or a plurality of second in particular electrochemical energy storage apparatuses. The energy storage apparatuses are provided for emitting and for accepting an electric current. The energy storage device also has a control apparatus which is provided for controlling the emission and the accepting of an electric current by means of at least one of the energy storage apparatuses. The energy storage device is characterised in that the energy density of a second energy storage apparatus is higher than the energy density of a first energy storage apparatus. The energy density is determined in the present case as the ratio of the energy stored in the energy storage apparatus in the completely charged state and the weight of the energy storage apparatus. The control apparatus is provided for emitting an electric current predominantly to control one or a plurality of first energy storage apparatus(es), in the event that the intensity of an electric current exceeds a predetermined current intensity limit value.

In the sense of the invention, an energy storage device is understood as meaning a device which is used for emitting, for accepting and for storing energy to a consumer. Preferably, the energy of the energy storage device is emitted as electric current. According to the invention, the energy storage device has one or a plurality of first energy storage apparatuses, one or a plurality of second energy storage apparatuses and a control apparatus. These apparatuses are particularly connected to one another electrically and/or mechanically. Preferably, the energy storage device has a plurality of first and second energy storage apparatuses, it being possible for the number of the first energy storage apparatuses to differ from the number of the second energy storage apparatuses.

In the sense of the invention, a first energy storage apparatus is understood as meaning an apparatus which is suitable in particular for emitting, for accepting and for storing energy, particularly an electric current. Preferably, the first energy storage apparatus is constructed as an electrical or electrochemical energy storage apparatus. Particularly preferably, the first energy storage apparatus is constructed as a galvanic cell, coil or capacitor. A first energy storage apparatus constructed as a galvanic cell preferably has at least one anode, a cathode and a separator. The separator accommodates an electrolyte and is arranged between the anode and the cathode. Preferably, the electrolyte has lithium ions. Preferably, the first energy storage apparatus has a thin-walled jacket, particularly for separating the contents from atmospheric influences. Preferably, two current conductors of the first energy storage apparatus extend out of the jacket thereof at least to some extent. Preferably, a first energy storage apparatus is constructed to be able to accept and/or emit a higher electric current than a second energy storage apparatus permanently and without cumulative damage. Preferably, the internal resistance of a first energy storage apparatus is smaller than the internal resistance of a second energy storage apparatus.

In the sense of the invention, a second energy storage apparatus is understood as meaning an apparatus which is suitable in particular for emitting, for accepting and for storing energy, particularly an electric current. Preferably, the second energy storage apparatus is constructed as an electrical or electrochemical energy storage apparatus. Particularly preferably, the second energy storage apparatus is constructed as a galvanic cell with at lest one anode, a cathode and a separator. The separator accommodates an electrolyte and is arranged between the anode and the cathode. Preferably, the electrolyte has lithium ions. Preferably, the second energy storage apparatus has a thin-walled jacket, particularly for separating the contents from atmospheric influences. Preferably, two current conductors of the second energy storage apparatus extend out of the jacket thereof at least to some extent.

In the sense of the invention, a control apparatus is understood as meaning an apparatus which is provided for controlling the emission and the accepting of energy, particularly of an electric current by means of at least one of the energy storage apparatuses. Preferably, the control apparatus controls the energy storage apparatuses belonging to the energy storage device in such a manner that higher powers or electric currents in particular are preferably exchanged with one or a plurality of first energy storage apparatuses. Preferably, the control apparatus is constructed to control all energy storage apparatuses present. Preferably, the control apparatus has a plurality of control apparatuses which are in each case assigned in particular to a first energy storage apparatus and a second energy storage apparatus. Preferably, power switches or power regulators are assigned to the control apparatus, which conduct or switch the electric currents, particularly also the total current, out of the first and second energy storage apparatuses. Preferably, the control apparatus is provided to control the power switches or power regulators. Preferably, the control apparatus or the control elements and the power switches or power regulators are constructed integrally. Preferably, the control apparatus is and/or the control elements are connected to a signal bus.

According to the invention, the energy storage device has one or a plurality of measuring apparatuses. In the sense of the invention, a measuring apparatus is understood as meaning an apparatus which temporarily detects a measured value, particularly of at least one of the energy storage apparatuses. Preferably, this measured value is representative for the internal resistance of an energy storage apparatus, the charging state thereof, the temperature thereof and/or the electric current which is supplied to or withdrawn from the energy storage apparatus. The measuring apparatus temporarily provides one or a plurality of measured values to the control apparatus. Preferably, the measuring apparatus has one or a plurality of sensors which are assigned in particular to the individual energy storage apparatuses, the control apparatus, power switches or power regulators, the heat-conducting apparatus, the connection apparatuses and/or other apparatuses. Preferably, the at least one measuring apparatus and/or the sensors thereof are connected to a signal bus. Preferably, the measuring apparatus has at least one thermocouple, a current measuring apparatus and/or a voltage measuring apparatus.

According to the invention, a first and a second energy storage apparatus differ by means of the energy density thereof. In the sense of the invention, energy density is understood as meaning the ratio of the energy stored in the energy storage apparatus in the completely charged state and the weight of the same energy storage apparatus. In the sense of the invention, completely charged state is understood as meaning that the charge of an energy storage apparatus is as large as possible without achieving the state of overcharging, which could in particular permanently lead to damaging or premature ageing of the energy storage apparatus. According to the invention, the energy density of a second energy storage apparatus is higher than the energy density of a first energy storage apparatus. Preferably, the quotient of the energy density of a first energy storage apparatus and the energy density of a second energy storage apparatus is less than 1, preferably less than 0.9, preferably less than 0.8, preferably less than 0.7, preferably less than 0.6, preferably less than 0.5, preferably less than 0.4, preferably less than 0.3, preferably less than 0.2, particularly preferably less than 0.1. Preferably, the aforementioned quotient is more than 0.01. If the energy storage device has a multiplicity of first and second energy storage apparatuses, the values of the quotient of the energy densities mentioned also apply for the homogeneously averaged energy densities of the first and second energy storage apparatuses.

The control apparatus is provided to temporarily process a detected measured value and/or the temporal curve thereof, particularly taking account of predetermined comparison values and/or predetermined temporal curves thereof. Particularly preferably, the control apparatus is provided for processing a measured value of the temperature of an energy storage apparatus and/or of an electric current intensity for controlling an energy storage apparatus. To this end, the control apparatus temporarily determines one or a plurality of differential values d made up of one or a plurality of detected measured values of one or a plurality of current intensities I₁ or I₂ (summarised in the following formula as Iₙ) and at least one predetermined current intensity limit value I_{g} (expanded with a further index for a first or second energy storage apparatus in the following formula):

d=Iₙ−I_{g,n}

The differential values d are used in particular for controlling the energy storage apparatuses. For the most part, a differential value d for an energy storage apparatus is negative in particular during the covering of a base load by means of the energy storage device. If, in a first case, a detected current intensity for in particular a second energy storage apparatus reaches or exceeds a predetermined current intensity limit value, then the control apparatus limits the current to be emitted or accepted by this second energy storage apparatus. If, in a second case, the detected temperature for in particular a second energy storage apparatus reaches or exceeds a predetermined current intensity limit value, then the control apparatus limits the current to be emitted or accepted by this second energy storage apparatus. To fulfill the current requirement or the current consumption, the control apparatus in this first case predominantly controls one or a plurality of first energy storage apparatuses for acceptance or emission. The quotient “q” of an electric current I₁ emitted or accepted by a first energy storage apparatus and an electric current I₂ emitted or accepted by a second energy storage apparatus fluctuates in particular as a function of the current requirement or the operating state of the consumer supplied:

$$q = \frac{{I}_{1}}{{I}_{2}} where 0 < q < 5000$$

The quotient q fluctuates temporally in particular. Preferably, q is intermittently between 0.01 and 1000, preferably between 0.1 and 100 and particularly preferably between 1 and 10. This calculation of q and the limit values mentioned also apply for a plurality of first and second energy storage apparatuses. Preferably, the differences d are, if necessary, calculated in particular for each second energy storage apparatus. Particularly preferred are [lacuna]

According to the invention, depending on the difference d, the control apparatus predominantly controls the one or plurality of first energy storage apparatuses and/or the one or plurality of second energy storage apparatuses for emitting or accepting an electric current. If the amount of power or the intensity of the electric current exceeds a predetermined limit value, particularly a predetermined current intensity limit value, the control apparatus is provided to predominantly withdraw the energy from or supply the energy to one or a plurality of first energy storage apparatuses. The control apparatus is provided, in the case of power values or electric currents which fall short of a predetermined limit value or current intensity limit value, to predominantly withdraw the energy from or supply the energy to one or a plurality of second energy storage apparatuses. Preferably, the control apparatus is provided to exclusively supply energy to or exclusively withdraw energy from first energy storage apparatuses or second energy storage apparatuses, as a function of the amount of power or the current intensity of the electric current. Preferably, the control apparatus is provided to control one or a plurality of electrical resistances assigned to the energy storage device with an electric current from one or a plurality of first and/or one or a plurality of second energy storage apparatuses.

In the sense of the invention, a current intensity limit value is understood as meaning a limit value which the current intensity of an electric current, which is supplied to or withdrawn from an energy storage apparatus, should not generally exceed. An exceeding of this current intensity limit value can effect a premature ageing of the loaded energy storage apparatus and/or lead to a serious damaging of the loaded energy storage apparatus. Preferably, a current intensity limit value is chosen as a function of the design, the age and/or the temperature of the respective energy storage apparatus. Preferably, in each case, a multiplicity of limit values or current intensity limit values are available in each case for consideration for the control apparatus for a first or a second energy storage apparatus. It is in particular an aim of the observance of the current intensity limit values that an overheating of one or a plurality of energy storage apparatuses is prevented. Preferably, the current intensity limit value of a first energy storage apparatus is approximately 500, 200, 150, 100, 50, 20 amperes, depending on the design, ageing and/or temperature. Preferably, the current intensity limit value of a second energy storage apparatus is approximately 250, 150, 100, 50, 20 amperes, depending on the design, ageing and/or temperature. Depending on the design, ageing and temperature, the current intensity limit values can also lie thereabove, however. Preferably, the current intensity limit value of a second energy storage apparatus is smaller than the current intensity limit value of a first energy storage apparatus, particularly in a manner dependent upon the design.

Electric currents which are supplied to or withdrawn from an energy storage apparatus also effect an electrical heating output. This heating output can, in the event of insufficient heat dissipation, lead to a temperature rise in the energy storage apparatus loaded with the electric current. Electrochemical energy storage apparatuses generally age faster with increasing temperatures, as a consequence of irreversible chemical reactions. As the control apparatus is provided to withdraw higher powers or more intense electric currents from or supply higher powers or more intense electric currents to predominantly one or a plurality of first energy storage apparatus, a second energy storage apparatus is advantageously subjected to smaller thermal loads. Thus, in particular, the ageing of a second energy storage apparatus is reduced, the useful operation period of the energy storage device is increased and the underlying object is achieved.

The developments of the invention which are to be preferred are described in the following.

Advantageously, an energy storage device according to the invention has a holding apparatus, a connection apparatus and/or a heat-conducting apparatus. Preferably, at least the heat-conducting apparatus and the energy storage apparatuses are connected to the holding apparatus. Preferably, the holding apparatus is constructed as a baseplate, frame or housing. Preferably, the energy storage apparatuses are accommodated in the holding apparatus with elastic or vibration-suppressing elements. Thus, damaging effects of mechanical loading or vibrations on the energy storage apparatuses can advantageously be reduced. Preferably, the heat-conducting apparatus and the energy storage apparatuses are accommodated by the holding apparatus in such a manner that the same contact the heat-conducting apparatus in a heat-conducting manner.

The connection apparatus is used in particular for the electrical connection to the supplied consumer. To this end, a connection apparatus is connected to one or a plurality of current conduction apparatuses, preferably to at least one connection cable or a contact rail. Preferably, the connection apparatus has one or a plurality of connection terminals. Particularly preferably, the connection apparatus may have two connection terminals of differing polarity.

The heat-conducting apparatus is preferably connected in a heat-conducting manner to the at least one first energy storage apparatus, particularly preferably to all of the energy storage apparatuses of the energy storage device. Preferably, the heat-sensitive components of the control apparatus are also connected in a heat-conducting manner to this heat-conducting apparatus. In particular, these heat-sensitive components of the control apparatus are power switches or power regulators which conduct or switch the electric currents and if appropriate also the total current out of the energy storage apparatuses. Preferably, coolant flows to or flows through the heat-conducting apparatus. To this end, the heat-conducting apparatus preferably has areas of enlarged surface, particularly preferably cooling ribs and/or at least one channel for the coolant. Preferably, the energy storage apparatuses are essentially of square construction and contact the heat-conducting apparatus in each case with a boundary surface. Preferably, the heat-conducting apparatus is constructed with a plurality of heat-conducting bodies. Preferably, these heat-conducting bodies are arranged in this holding apparatus in each case between two rows of essentially square energy storage apparatuses and have at least one channel and/or at least one area of enlarged surface. Preferably, coolant flows to or flows through a heat-conducting body. Preferably, the heat-conducting body has areas of enlarged surface, particularly preferably cooling ribs and/or at least one channel for the coolant.

Preferably, the energy storage device further has at least one current measuring apparatus which is preferably arranged between the connection apparatus and the energy storage apparatuses. Particularly preferably, the energy storage apparatus has a central current measuring apparatus which gives information about the total current withdrawn from the energy storage device.

Advantageously, the energy storage device is constructed with a heat-conducting apparatus. Advantageously, the energy storage apparatuses are connected to the heat-conducting apparatus in a heat-conducting manner. Preferably, the first energy storage apparatus is arranged between the heat-conducting apparatus and the second energy storage apparatus. The energy storage apparatuses are preferably essentially of square construction. Thus, an in particular space-saving arrangement of the apparatuses can be achieved, a first energy storage apparatus being able to dissipate heat both to the heat-conducting apparatus and to the second energy storage apparatus. A first energy storage apparatus, if necessary, therefore uses the heat capacity of a second energy storage apparatus which contacts in a heat-conducting manner. Thus, peaks in the temperature curve of a first energy storage apparatus can advantageously be reduced.

Advantageously, the control apparatus is provided to feed an electric current between at least two of the energy storage apparatuses under predetermined conditions. Preferably, the control apparatus is provided to feed an electric current between one or a plurality of first energy storage apparatus(es) and one or a plurality of second energy storage apparatus(es) under predetermined conditions. Particularly preferably, the control apparatus is provided to feed an electric current between a first energy storage apparatus and a second energy storage apparatus under predetermined conditions. Predetermined conditions are in particular present if a larger amount of energy has been withdrawn from a first energy storage apparatus. This is particularly the case if the drive of a motor vehicle supplied by the energy storage device has accelerated the same or driven the same uphill over a minimum period of time. If the current required for supplying the automotive drive has exceeded the predetermined current intensity limit value, the drive is predominantly supplied by at least one first energy storage apparatus. The control apparatus is preferably provided, in particular following analysis of measured values, particularly of a current intensity and/or a current-time integral, and comparison with a current intensity limit value and/or a predetermined charge quantity, to adopt a noticeably reduced charging state of a first energy storage apparatus. To increase the charging state and particularly for preparing for a renewed acceleration of the motor vehicle or uphill driving, the control apparatus feeds a current from at least one second energy storage apparatus to at least one first energy storage apparatus until in particular, a desired charging state of the at least one first energy storage apparatus is reached. Predetermined conditions also exist if energy has been fed to a first energy storage apparatus from a drive motor driven like a generator, particularly in the case of decelerating a motor vehicle and/or the overrun thereof. In this case, the braking energy stored predominantly in at least one first energy storage apparatus could lead to an undesirably high charge of the first energy storage apparatus. In this case, the control apparatus is provided to feed a current from the first energy storage apparatus to a second energy storage apparatus, particularly to reduce the charge of the at least one first energy storage apparatus.

Advantageously, the charge capacity of a first energy storage apparatus is adapted to the charge capacity of a second energy storage apparatus. Preferably, the charge capacity of a first energy storage apparatus is smaller than the charge capacity of a second energy storage apparatus. Particularly preferably, the charge capacity of a first energy storage apparatus is less than two thirds of the charge capacity of a second energy storage apparatus. Preferably, the total charge capacity of all first energy storage apparatuses is smaller than the total charge capacity of all second energy storage apparatuses. Preferably, the energy storage device is equipped with more second energy storage apparatuses than first energy storage apparatuses. The adaptation of the charge capacities takes place in particular for taking account of underlying operating profiles of the motor vehicle. Advantageously, the total charge capacity of the first energy storage apparatuses takes account of a smaller time portion of operating states with high power output to the drive motor, particularly of a motor vehicle. Preferably, in expectation of operation with a larger portion of accelerating travel and/or higher loads, an energy storage device is equipped with an overall higher charge capacity in the form of first energy storage apparatuses. Preferably, this total charge capacity of the first energy storage apparatus is less than a third of the overall charge capacity of the energy storage device, preferably less than a quarter of this overall charge capacity, preferably less than a fifth of the overall charge capacity, particularly preferably less than a tenth of the overall charge capacity, at least however more than a fiftieth of the overall charge capacity. Preferably, the portion of the charge capacity of the first energy storage apparatuses of the overall charge capacity of the energy storage device is formed by the ratio of the numbers of the first or the second energy storage apparatuses.

Advantageously, the control apparatus is signal connected to a superordinate control, particularly of the motor vehicle or the supplied machine or installation. The control apparatus is provided to at least temporarily exchange at least one predetermined signal. Preferably, signals are exchanged, which give information about operating states of the energy storage device, about the progress of various processes, such as charging or discharging processes, relating to energy storage apparatuses, error messages, etc. Preferably, the superordinate control of the control apparatus transmits signals which give information about the maximum permissible power consumption of auxiliaries of the motor vehicle, the auxiliaries of the operated installation or the auxiliaries of the machine. Preferably, a storage apparatus is assigned to the control apparatus. This storage apparatus is particularly intended for storing operating data, predetermined limit values, predetermined current intensity limit values, predetermined temperature limit values, parameter profiles, messages relating to desired and undesirable operating states of the energy storage device and/or error messages. Preferably, the contents of the storage apparatuses of a superordinate control can be read and/or overwritten by a superordinate control, particularly in the case of maintenance processes.

Advantageously, at least one first energy storage apparatus and at least one second energy storage apparatus is surrounded at least to some extent, preferably predominantly, particularly preferably completely, by a housing. Preferably, exactly one first energy storage apparatus and one second energy storage apparatus is surrounded at least to some extent by a housing. Preferably, at least three energy storage apparatuses are surrounded at least to some extent by a housing. Preferably, the housing is composite in construction, particularly with a first shaped part and a second shaped part. The shaped parts are provided to be connected to one another, in particular in a materially bonded and/or non-positive manner around the energy storage apparatuses. Preferably, the second shaped part is in particular connected in a heat-conducting manner to the first energy storage apparatus, particularly to all energy storage apparatuses. Preferably, the second shaped part is constructed at least to some extent with a metallic material. Preferably, the second shaped part is in particular connected in a heat-conducting manner to the heat-conducting apparatus of the energy storage apparatus. With the application of a temperature gradient, heat energy is preferably fed to or withdrawn from the energy storage apparatuses, depending on the direction of the temperature gradient. Preferably, the second shaped part is coated at least to some extent with an electrically insulating material, particularly on the side facing the energy storage apparatuses. Preferably, the housing has two connection apparatuses and/or a control apparatus or a control element. Preferably, the second shaped part is constructed as a container and the first shaped part is constructed as an associated lid. Preferably, at least the second shaped part is adapted to the shape of the energy storage apparatuses to be accommodated. Preferably, at least one shaped part is shaped by means of a shaping method, particularly a reshaping method.

Advantageously, at least one electrode of an energy storage apparatus, particularly preferably at least one cathode, has a compound with the formula LiMPO₄, where M is at least one transition metal cation of the first order. The transition metal cation is chosen from the group consisting of Mn, Fe, Ni and Ti or a combination of these elements. The compound has a superordinate olivine structure.

According to the invention, at least one energy storage apparatus preferably has a separator which does not or only poorly conducts electrons and which consists of a substrate which is at least partially permeable to material. The substrate is preferably coated on at least one side with an inorganic material. Preferably an organic material, which is preferably configured as a non-woven fleece, is used as a substrate which is at least partially permeable to material. The organic material, preferably constructed with a polymer and particularly preferably with polyethylene terephthalate (PET), is coated with an inorganic ion-conducting material which is preferably ion-conducting in a temperature range from 40° C. to 200° C. The inorganic ion-conducting material preferably comprises at least one compound from the group of oxides, phosphates, sulphates, titanates, silicates, aluminosilicates with at least one of the elements Zr, Al, Li, particularly preferably zirconium oxide. Preferably, the inorganic ion-conducting material has particles with a largest diameter below 100 nm. A separator of this type is sold in Germany by Evonik AG under the brand name “Separion”, for example.

Advantageously, an energy storage device with at least one first energy storage apparatus, a second energy storage apparatus and a control apparatus is advantageously operated in such a manner that the control apparatus preferably controls at least one first energy storage apparatus in order to emit an electric current, particularly with a current intensity above a predetermined current limit value. Preferably, the control apparatus processes at least one signal of at least one measuring apparatus, in particular of an ammeter, the signal particularly giving information about the current intensity of the total electric current withdrawn from the energy storage device. If the measured total current exceeds a predetermined current limit value, the control apparatus controls the energy storage apparatuses in such a manner that the current is predominantly withdrawn from the at least one first energy storage apparatus. Electric power or electric current is only withdrawn from the second energy storage apparatus in this operating state until the level of the maximum permissible current intensity for the second energy storage apparatus is reached. If the electric current demanded of the energy storage device falls below a predetermined current intensity limit value, the control apparatus predominantly controls the second energy storage apparatus to emit this current. Advantageously, the base load demanded of the energy storage device is predominantly provided by the at least one second energy storage apparatus, whereas load peaks are handled with a significant contribution of the at least one first energy storage apparatus. Thus, the electric heating output as a consequence of current withdrawal from a second energy storage apparatus and thus the temperature thereof are limited. As a result, the ageing of a second energy storage apparatus can be reduced, by means of irreversible chemical reactions in particular and the operation period of a second energy storage apparatus can be increased.

Advantageously, the energy storage device is operated in such a manner that the control apparatus feeds an electric current between at least two of the energy storage apparatuses under predetermined conditions. Preferably, the control apparatus feeds a current between a first energy storage apparatus and a second energy storage apparatus under predetermined conditions. Predetermined conditions are present if a first energy storage apparatus is discharged appreciably, particularly if the current charge of the first energy storage apparatus is less than half of the permissible charge. Preferably, to this end, the control apparatus processes at least one signal of at least one measuring apparatus, in particular of an ammeter, the signal particularly giving information about the charging state of the first energy storage apparatus in comparison with predetermined limit values. In this case, energy or electric current is fed from a second energy storage apparatus to the first energy storage apparatus. Thus, the first energy storage apparatus is prepared for a later higher loading, particularly accelerating travel or uphill travel of a motor vehicle. A predetermined condition also exists if energy and/or overrun is fed to an energy storage apparatus from a drive motor of a motor vehicle, which is driven like a generator, particularly in the case of a decelerating operation. With the feeding of a current from this first energy storage apparatus to the second energy storage apparatus by means of the control apparatus, an overcharging of the first energy storage apparatus can be minimised. Thus, damaging or ageing of a first energy storage apparatus is reduced. Preferably, a resistance is assigned to the energy storage apparatus. This is used in particular for reducing the charge of an energy storage apparatus. Preferably, the control apparatus controls this resistance for the partial discharging of an energy storage apparatus.

Advantageously, an energy storage device according to the invention is operated in such a manner that in particular during a charging operation of an in particular second energy storage device, the electric voltage thereof, particularly the terminal voltage thereof is monitored. To this end, a measuring apparatus temporarily detects the electric voltage Uₙ of one or a plurality of, in particular second energy storage apparatuses, in particular during a charging process. Further, the measuring apparatus provides the detected measured values, in particular detected terminal voltages of the control apparatus. Using these measured values and predetermined voltage limit values U_{g}, the control apparatus determines one or a plurality of second differential values d₂.

d₂=Uₙ−U_{g}

During a charging process of an energy storage apparatus, a second differential value d₂ is for the most part negative. The control apparatus is provided to control a charging process of an energy storage apparatus as a function of this differential value d₂. If a second differential value d₂ approaches the value 0 or becomes positive, the control apparatus preferably interrupts further energy supply. A predetermined voltage limit value U_{g} is in particular chosen as a function of design, ageing and/or temperature of an energy storage apparatus. Preferably, the voltage limit value U_{g} is chosen slightly higher than the nominal voltage or the electrochemical voltage of an energy storage apparatus. Preferably, the voltage limit value U_{g} is up to 120%, 115%, 110%, 105% of the nominal voltage of the energy storage apparatus. Preferably, for lengthening th service life of an energy storage apparatus, a smaller voltage limit value U_{g} is chosen for the connection of a charging process.

Preferably, one temporally changeable, in particular pulsed electric current is fed in each case to one or a plurality of second energy storage apparatuses at least temporarily, in particularly during a charging process. Preferably, one electric current of essentially constant current intensity is fed in each case to one or a plurality of first energy storage apparatuses at least temporarily, in particularly during a charging process.

Further advantages, features and application possibilities of the present invention result from the following description in connection with the figures. In the figures:

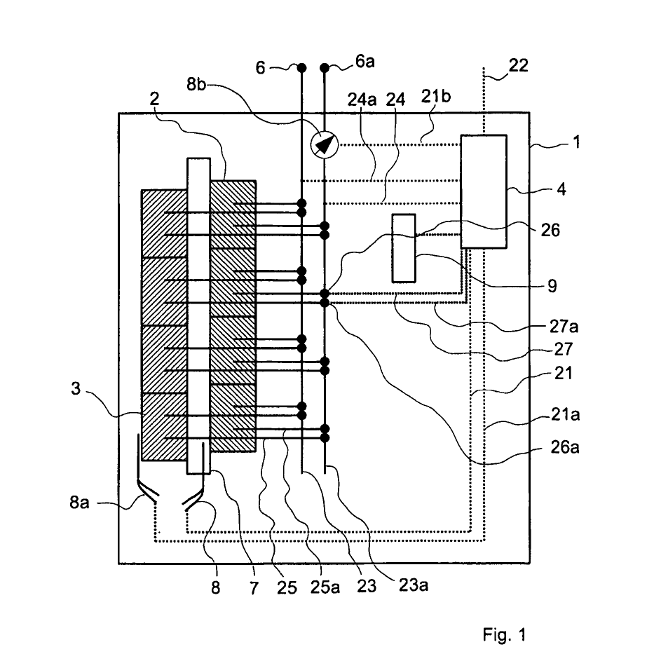

FIG. 1 schematically shows an embodiment of an energy storage device according to the invention with complementing apparatuses,

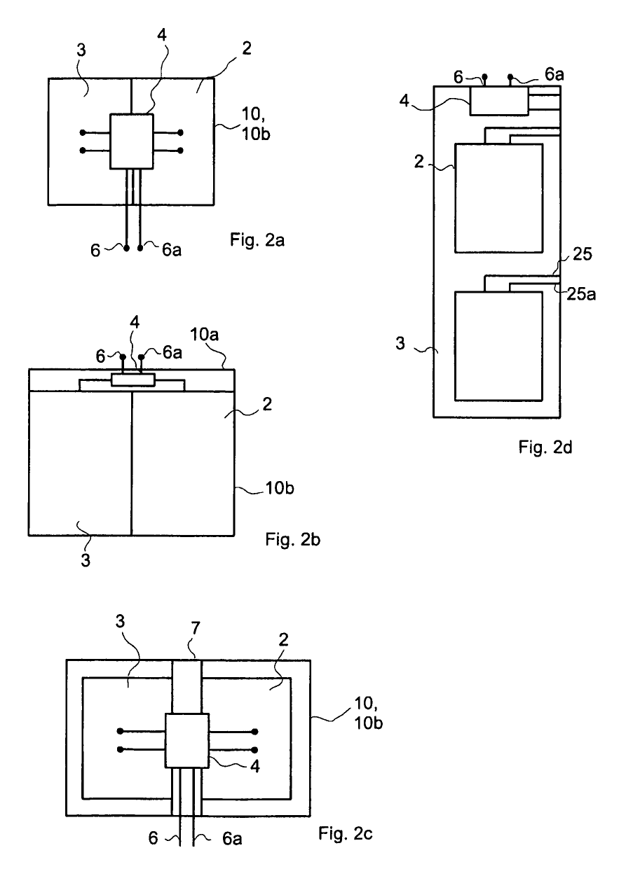

FIG. 2 schematically shows further embodiments of energy storage devices according to the invention with composite housings.

FIG. 1 schematically shows an embodiment of an energy storage device 1 according to the invention with a few complementing apparatuses. Control lines 21, 21a, 21b, 22, 24, 24a, 27, 27a are shown dashed therein.

The energy storage device 1 has a plurality of first energy storage apparatuses 2 and a plurality of second energy storage apparatuses 3, which contact the heat-conducting apparatus 7 in a heat-conducting manner. The energy storage apparatuses are essentially of square construction and in each case contact the heat-conducting apparatus 7 by means of a boundary surface. Both the heat-conducting apparatus and the first energy storage apparatus 2 each have a thermocouple 8, 8a. These are only illustrated by way of substitution for a multiplicity of thermocouples and further measuring apparatuses. These are only connected to the control apparatus 4 via control lines 21, 21a. A control apparatus 9 is assigned to the control apparatus 4, in which data, current intensity limit values, operating profiles, error messages, etc. are stored. The control apparatus 4 is signal connected via a connection line 22 to a superordinate control which is not illustrated. The individual energy storage apparatuses 2, 3 are connected via power cables 25, 25a and via power switches 26, 26a to central current lines 23, 23a. These power switches 26, 26a are actuated by the control apparatus 4 via control lines which are not illustrated. The central current lines 23, 23a open into the connection apparatuses 6, 6a which are connected at least indirectly to the electric consumer. Not illustrated are a multiplicity of current measuring apparatuses which detect the current also in the connection cables 25, 25a and provide the same to the control apparatus 4. Depending on the design, these current measuring apparatuses are also integrally constructed with the power switches 26, 26a. The central current line 23a has a central ammeter 8b for detecting the total current provided to the consumer. Via the signal line 21b, the central ammeter 8b provides at least one measured value to the control apparatus 4. The control apparatus 4 processes the signals of various measuring apparatuses 8, 8a, 8b and actuates the power switches 26, 26a via control lines 27, 27a. Preferably, these power switches 26, 26a are constructed as power regulators which enable the conduction of a limited current.

In the present case, the second energy storage apparatuses are constructed as electrochemical cells. In the present case, the first energy storage apparatuses are also constructed as electrochemical cells. Preferably, the first energy storage apparatuses 2 are constructed as capacitors or coils, the energy densities of which are smaller than the energy densities of the energy storage apparatuses 3. Advantageously, the first energy storage apparatuses 2 constructed as coils or capacitors are in a position to emit or to accept substantially greater currents. Thus, substantially larger currents can advantageously be provided to the consumer in a temporally limited manner than if the energy storage device 1 were to have two second energy storage apparatuses 3 exclusively.

FIG. 2 shows further embodiments of energy storage devices according to the invention. These stand out on account of the fact that a first energy storage apparatus 2 and a second energy storage apparatus 3 are accommodated by a housing 10. In this case, the housing 10 preferably contacts the energy storage apparatuses 2, 3 particularly in a heat-conducting manner, although not illustrated in the figure. Particularly preferably, the energy storage apparatuses 2, 3 are wedged into the housing 10 to improve the thermal contact. All embodiments of FIG. 2 have a control apparatus 4 or at least one control element which at least temporarily exchange(s) signals with other control apparatuses or control elements. Preferably, the control apparatus 4 and the power switches or power regulators, which are not illustrated, are constructed integrally. An energy storage device according to FIG. 2 virtually constitutes a smallest unit which can be especially electrically linked to one another in any number and arranged geometrically with respect to one another.

FIG. 2a shows a further embodiment of an energy storage device according to the invention. This has a first energy storage apparatus 2, a second energy storage apparatus 3, a control apparatus 4, a housing 10 or the second shaped part thereof 10b, as well as two connection terminals 6, 6a. Not illustrated are the power switches or power regulators and also the first shaped part of the housing 10, which is constructed as a lid. The second shaped part 10b of the housing 10 is constructed as a metal sheet and surrounds the energy storage apparatuses 2, 3 in such a manner that the apparatuses are pretensioned against one another. Thus, the heat conduction is improved by the boundary surfaces of the energy storage apparatuses 2, 3.

FIG. 2b schematically shows a side view of the embodiment according to FIG. 2a. The control apparatus 4 is integrally constructed with the power regulators or power switches and the connection terminals 6, 6a, which are not illustrated. The components can however also be of unobtrusive construction. Preferably, the power switches or power regulators, which are not illustrated, are connected in a heat-conducting manner to the second shaped part 10b.

FIG. 2c schematically shows a modification of the embodiment of the energy storage device according to the FIGS. 2a and 2b with a heat-conducting apparatus 7. The heat-conducting apparatus 7 is arranged between the energy storage apparatuses 2, 3 in such a manner that the heat-conducting apparatus 7 also contacts the second shaped part 10b of the housing 10 in a heat-conducting manner. Further, the second shaped part 10b surrounds the contained apparatuses in such a manner that the same are pretensioned against one another. The control apparatus 4 is integrally constructed with the power regulators or power switches and the connection terminals 6, 6a, which are not illustrated. Preferably, the power switches or power regulators, which are not illustrated, are connected in a heat-conducting manner to the second shaped part 10b.

FIG. 2d shows a further embodiment of an energy storage device according to the invention. The energy storage apparatuses 2, 3 are arranged above one another. The second shaped part 10b of the housing 10 has conductor tracks on the right inner side of the second shaped part 10b, which are electrically insulated against the metallic wall thereof and are not illustrated. These conductor tracks are used for contacting the energy storage apparatuses 2, 3. The conductor tracks lead via the power switches or power regulators, which are not illustrated, and the control apparatus 4 to the terminals 6, 6a. Preferably, the control apparatus 4 and the power switches or power regulators, which are not illustrated, are combined to form a common module. Preferably, the energy storage apparatuses 2, 3 are constructed with connections on an enveloping surface facing the conductor tracks. Preferably, the power switches or power regulators, which are not illustrated, are connected in a heat-conducting manner to the second shaped part 10b.

1-12. (canceled)

13. An energy storage device, comprising:
one or a plurality of first energy storage apparatuses;
one or a plurality of second electrochemical energy storage apparatuses provided for emitting and for accepting an electric current in each case;
a control apparatus provided for controlling emission and accepting of an electric current by the same one or a plurality of energy storage apparatuses;
a measuring apparatus provided to detect one or a plurality of measured values, or intensity of electric current emitted or accepted by these energy storage apparatuses in each case, and further provided to temporarily provide these one or a plurality of measured values to the control apparatus;
wherein
the energy densities of these one or plurality of second energy storage apparatuses are higher than the energy densities of these one or plurality of first energy storage apparatuses;
the control apparatus is provided to determine one or a plurality of differential values from the one or plurality of detected current intensities and one or a plurality of predetermined current intensity limit values;
the control apparatus is provided to predominantly control these one or plurality of first energy storage apparatuses as a function of the one or plurality of differential values for emitting an electric current; and
the internal resistance of at least one first energy storage apparatus is smaller than the internal resistance of a second energy storage apparatus.

14. The energy storage device according to claim 13, wherein the second energy storage apparatus has a thin-walled jacket.

15. The energy storage device according to claim 13, wherein the control apparatus controls the energy storage apparatuses belonging to the energy storage device such that higher powers or electric currents are exchanged with one or a plurality of first energy storage apparatuses.

16. The energy storage device according to claim 13, wherein the energy storage device includes at least one measuring apparatus that at least temporarily detects at least one measured value of at least one of the energy storage apparatuses, wherein this measured value is representative for the internal resistance of an energy storage apparatus.

17. The energy storage device according to claim 13, wherein the energy storage device includes at least one measuring apparatus that at least temporarily detects at least one measured value of at least one of the energy storage apparatuses, wherein this measured value is representative for a charging state of an energy storage apparatus.

18. The energy storage device according to claim 13, wherein the energy storage device includes at least one measuring apparatus that at least temporarily detects at least one measured value of at least one of the energy storage apparatuses, wherein this measured value is representative for a temperature of the energy storage apparatus.

19. The energy storage device according to claim 13, wherein the energy storage device includes at least one measuring apparatus that at least temporarily detects at least one measured value of at least one of the energy storage apparatuses, wherein this measured value is representative for electric current, which is supplied to or withdrawn from the energy storage apparatus.

20. The energy storage device according to claim 13, wherein the control apparatus limits the current to be emitted or accepted by this second energy storage apparatus if a detected current intensity for this second energy storage apparatus reaches or exceeds a predetermined current intensity limit value.

21. The energy storage device according to claim 13, wherein the control apparatus limits the current to be emitted or accepted by this second energy storage apparatus if a detected temperature for this second energy storage apparatus reaches or exceeds a predetermined temperature limit value.

22. The energy storage device according to claim 13, wherein the control apparatus is provided, in the case of power values or electric currents that fall short of a predetermined limit value or current intensity limit value, to predominantly withdraw the energy from or supply the energy to one or a plurality of the second energy storage apparatuses.

23. The energy storage device according to claim 13, further comprising:
a holding apparatus that accommodates this one or plurality of energy storage apparatuses;
a connection apparatus that is connected to one or a plurality of connection apparatuses; and
a heat-conducting apparatus that is connected in a heat-conducting manner to this one or plurality of energy storage apparatuses.

24. The energy storage device according to claim 13, further comprising:
a heat-conducting apparatus,
wherein a first energy storage apparatus, a second energy storage apparatus, and the heat-conducting apparatus are connected to one another in particular in a heat-conducting manner,
wherein the first energy storage apparatus is arranged between the heat-conducting apparatus and the second energy storage apparatus.

25. The energy storage device according to claim 13, wherein the control apparatus is provided to feed an electric current between one or a plurality of first energy storage apparatus(es) and one or a plurality of second energy storage apparatus(es) under predetermined conditions.

26. The energy storage device according to claim 13, wherein charge capacities of the one or plurality of first energy storage apparatuses are adapted to charge capacities of the one or plurality of second energy storage apparatuses.

27. The energy storage device according to claim 13,
wherein the control apparatus is signal connected to a superordinate control;
wherein the control apparatus temporarily exchanges one or a plurality of predetermined signals with the superordinate control; and
wherein a control apparatus is assigned to the control apparatus, which is provided for storing data.

28. The energy storage device according to claim 13, further comprising:
a housing that surrounds the first energy storage apparatus and the second energy storage apparatus,
wherein the housing includes a first shaped part and a heat-conducting second shaped part, which are connected to one another, in regions, in a materially bonded and/or non-positive manner, and
wherein the second shaped part is connected in a heat-conducting manner to the one or plurality of the energy storage apparatuses.

29. The energy storage device according to claim 13, wherein the one or plurality of energy storage apparatuses are constructed as a galvanic cell with two or a plurality of electrodes in each case,
wherein the one or plurality of electrodes, constructed as a cathode, includes a compound with the formula LiMPO₄, wherein M is at least one transition metal cation of the first order, wherein this transition metal cation is chosen from the group consisting of Mn, Fe, Ni and Ti or a combination of these elements, and wherein the compound has a superordinate olivine structure.

30. The energy storage device according to claim 13, wherein at least one energy storage apparatus is constructed as a galvanic cell with at least one separator, wherein the separator does not or only poorly conducts electrons and includes a substrate that is permeable to material, or partially permeable to material,
wherein the substrate is coated on at least one side with an inorganic material,
wherein an organic material, which is configured as a non-woven fleece, is used as a substrate which is at least partially permeable to material,
wherein the organic material includes a polymer or polyethylene terephthalate (PET),
wherein the organic material is coated with an ion-conducting inorganic material or which is ion-conducting in a temperature range from −40° C. to 200° C.,
wherein the ion-conducting inorganic material is at least one compound from the group of oxides, phosphates, sulphates, titanates, silicates, aluminosilicates of at least one of the elements Zr, Al, Li, or zirconium oxide,
and wherein the ion-conducting inorganic material has particles with a largest diameter below 100 nm.

31. A method for operating an energy storage device comprising:
one or a plurality of first energy storage apparatuses;
one or a plurality of second, or electrochemical, energy storage apparatuses, wherein energy densities of these one or plurality of second energy storage apparatuses are higher than energy densities of these one or plurality of first energy storage apparatuses;
a control apparatus that controls emission and accepting of an electric current by a same one or a plurality of energy storage apparatuses; and
a measuring apparatus that temporarily detects one or a plurality of measured values, or intensity, of the electric current emitted or accepted by these energy storage apparatuses in each case, and provides the same to the control apparatus;
wherein the control apparatus determines one or a plurality of differential values from the one or plurality of detected electric current intensities and one or a plurality of predetermined current intensity limit values;
wherein the control apparatus predominantly controls these one or plurality of first energy storage apparatuses as a function of the one or plurality of differential values for emitting an electric current; and
wherein internal resistance of at least one first energy storage apparatus is smaller than internal resistance of at least one second energy storage apparatus.

32. The method according to claim 31, wherein the control apparatus feeds an electric current between two or more energy storage apparatuses under predetermined conditions.

33. The method according to claim 31, wherein, whilst electrical energy is fed to this one or plurality of energy storage apparatuses, a measuring apparatus temporarily detects a measured value, or electric voltage, of this one or plurality of energy storage apparatuses, and provides the same to the control apparatus,
wherein the control apparatus determines one or a plurality of second differential values from the detected measured value, or from the detected electric voltage, and one or a plurality of voltage limit values; and
wherein the control apparatus predominantly controls these one or plurality of first energy storage apparatuses as a function of the one or plurality of second differential values for emitting an electric current; and
wherein the control apparatus interrupts supply of energy to these one or plurality of energy storage apparatuses as a function of this one or plurality of second differential values.
